(19) United States
(12) Patent Application Publication
(10) Pub. No.: US 2016/0365578 A1
(43) Pub. Date: Dec. 15, 2016

(54) SODIUM TRANSITION METAL SILICATE AND METHOD OF FORMING SAME

(71) Applicant: Sharp Kabushiki Kaisha, Osaka (JP)

(72) Inventors: Emma Kendrick, North Warnborough (GB); Joshua Charles Treacher, Oxford (GB)

(21) Appl. No.: 14/738,120

(22) Filed: Jun. 12, 2015

(51) Int. Cl. H01M 4/58; B01J 23/75; B01J 23/755; B01J 23/745; B01J 23/889; C01B 33/32; B01J 23/34

(52) U.S. Cl. CPC H01M 4/5825; C01B 33/32; B01J 23/75; B01J 23/34; B01J 23/745; B01J 23/8892; B01J 23/755; C01P 2006/16; C01P 2004/62; C01P 2004/61; C01P 2006/12; C01P 2006/40; H01M 2004/028

(57) ABSTRACT

A macroporous sodium transition metal silicate material includes a composition represented by AₐM¹_{b}M²_{c}X_{d}Oₑ, wherein A is sodium or a mixture of sodium with lithium and/or potassium; M¹ is one or more transition metals; M² is one or more metals and/or metalloids; X is silicon or a mixture containing silicon and one or more elements selected from phosphorus, boron and aluminium; a is >0; b is >0; c is ≧0; d is ≧1; and e is ≧2. A method of forming the macroporous sodium transition metal silicate material includes mixing one or more transition metal precursor materials in a solvent to form a transition metal mixture; adding one or more silicate precursors to the transition metal mixture to form a precursor mixture; raising the pH of the precursor mixture to form a precipitate; stirring the mixture; aging and drying the mixture; washing the mixture; and drying.

### TECHNICAL FIELD

The present disclosure is related to a macroporous sodium transition metal silicate material and a method for forming said material. The present disclosure also relates to electrodes which contain an active material including a macroporous sodium transition metal silicate material, and the use of such an electrode, for example, in a sodium ion battery.

### BACKGROUND ART

Sodium ion batteries are similar in many ways to lithium ion batteries. They are both reusable secondary batteries which include an anode (negative electrode), a cathode active (positive electrode), and an electrolyte. The two electrodes are separated by a porous film which contains an ionically conducting electrolyte. These devices can both store energy and charge and discharge via a similar mechanism. During charge, a voltage is applied and alkali-ions deintercalate from the cathode and intercalate into the anode. Upon discharge, the same process occurs but ions migrate in the opposite direction from the anode to the cathode, driving electrons around an external circuit provided with the battery.

Catalysts containing transition metals are used for many applications including hydrogenation reactions, cracking of petroleum derived compounds, Fischer-Tropsch synthesis, hydrodesulphurisation, and hydroformylation. In these reactions the reaction media, typically a gas or liquid, penetrates the porous catalyst and adsorbs on to the surface of the active catalytic sites. Through this adsorption the catalytic site provides an environment in which the kinetic energy barrier for the reaction is lowered, thereby increasing the rate of the reaction and often providing a commercially viable synthesis route for a particularly desired compound.

Active materials for sodium-ion batteries and materials suitable for catalysis should be optimized for use. For example, in both applications the material structure should be optimized for surface area, porosity, and/or particles size. For a sodium ion battery, in order to optimize the specific capacity of a poor conducting material such as a silicate, small diffusion path lengths within small primary particle sizes are typically needed, and larger secondary particles should contain porosity to allow electrolyte to penetrate the particle. In the case of a catalyst, a small particle size and thus high surface area is desirable as this maximizes the surface sites available for catalysis maximizing the efficiency of the material.

U.S. Patent Application Publication No. 2012/0227252 (Nazari, published Sep. 13, 2013) describes the preparation of lithium transition metal silicates, and in particular the preparation of a silicate cathode for a lithium ion battery including: preparing an Olivine structure having a flake-like structure; carbon coating the Olivine structure; and shaping the Olivine structure for use as part of a cathode.

U.S. Patent Application Publication No. 2013/0052544 (Ohkubo et al., published Feb. 28, 2013) describes a cathode material which contains a lithium transition metal silicate of small particle size and low crystallinity. The material is described to be a useful cathode active material in a non-aqueous electrolyte secondary battery, capable of undergoing a charge-discharge reaction at room temperature.

It is noted that synthesis techniques for lithium transition metal silicate materials cannot be directly applied to their sodium analogues. For instance a hydrothermal synthesis method by Lyness et al., Chemical Communications, 2007, Issue 46, pages 4890-4892 describe a hydrothermal synthesis method for Li₂CoSiO₄ that produces only an amorphous product if the technique is applied to Na₂CoSiO₄. This method was based upon a synthesis for Li₂FeSiO₄ described by Dominko et al., Electrochemistry Communications, Volume 8, Issue 2, February 2006, Pages 217-222. The difficulty in reproducing the sodium transition silicates by the lithium transition silicate methods is possibly due to the increased solubility of the sodium cation.

International Application Publication No. 2010/066439 (Kallfass et al., published Apr. 28, 2011) describes alkali metal doped phosphate materials that contain 60 Mol % to 90 Mol % phosphate ions (PO₄³⁻) which can be partially substituted with silicate ions (SiO₄⁴⁻). These phosphate materials are said to be electrochemically active and suitable electrode materials for use in primary or secondary batteries.

Sodium ion analogues Na₂MgSiO₄ and Na₂ZnSiO₄ are reported in Solid State Ionics 7 (1982) 157-164; Solid State Ionics 18 & 19 (1986) 577-581; and Materials Research Bulletin, (1989), Vol. 24. Pp. 833-843, to be useful ionic conductors. However, although conductivity tests have been performed, neither of these materials is redox active and therefore cannot be used as a cathode.

U.S. Pat. No. 6,872,492 (Barker et al., published Mar. 29, 2005) describes a material for a sodium ion cathode with the formula of AₐMb(XY₄)_{c}Z_{d}, where (XY₄) is defined as being selected from the group consisting of X′O₄-x, Y′ₓ, X′O_{4-y}, Y′_{2y}, X″S₄, and mixtures thereof, where X′ is selected from the group consisting of P, As, Sb, Si, Ge, S and mixtures thereof; X″ is selected from the group consisting of P, As, Sb, Si, Ge and mixtures thereof; Y′ is selected from the group consisting of halogen, S, N, and mixtures thereof; 0≦x<3; and 0<y≦2; and 0<c≦3. However, there are no specific examples relating to silicate containing materials. Moreover, there is no electrochemical data or any other evidence to support the utility of SiO₄-containing materials as sodium ion cathode materials.

Nyten et al. (Electrochemical performance of Li₂FeSiO₄ as a new Li-battery cathode material, Electrochemistry Communications 7 (2005) 156-160) reports the electrochemical performance of Li₂FeSiO₄ and Li₂FeGeO₄. The electrochemical performance of Li₂FeSiO₄ can also be improved by the addition of a carbon coating as reported by Gong et al. in Electrochemical and Solid State Letters, 11 (5) A60-63 (2008) and in Zhang et al., Electrochemical and Solid State Letters, 12 (7) A136-39 (2009).

Chen et al. (Na₂MnSiO₄ as a positive electrode material for sodium secondary batteries using an ionic liquid electrolyte, Electrochemistry Communications 45, 63-66 (2014)) have synthesised Na₂MnSiO₄/carbon composite via a sol-gel method and tested at elevated temperatures with an ionic liquid electrolyte.

### SUMMARY OF INVENTION

In accordance with one aspect of the present disclosure, a method is provided of forming a macroporous sodium transition metal silicate material including a composition represented by Chemical Formula (1):

AₐM¹_{b}M²_{c}X_{d}Oₑ (1)

wherein A is sodium or a mixture of sodium with lithium and/or potassium; M¹ is one or more transition metals; M² is one or more metals and/or metalloids; X is silicon or a mixture containing silicon and one or more elements selected from phosphorus, boron and aluminium; a is >0; b is >0; c is ≧0; d is ≧1; and e is ≧2, the method including: mixing one or more transition metal precursor materials in a solvent to form a transition metal mixture; adding one or more silicate precursors to the transition metal mixture to form a precursor mixture; adjusting the pH of the precursor mixture to form a mixture of a precipitate of a silicate and a metal cation; stirring the mixture including the precipitate; aging the stirred mixture including the precipitate; drying the aged mixture including the precipitate to remove the solvent therefrom, the drying forming one or more secondary salts; washing the mixture including the precipitate and the one or more secondary salts with an additional solvent to remove the secondary salt; and drying the washed mixture.

In some embodiments, the method further includes annealing the aged and dried mixture including the precipitate and the one or more secondary salts prior to washing. In some embodiments, the annealing is performed at a temperature of 120° C. to 1000° C. for a time of 10 minutes to 12 hours.

In some embodiments, the one or more transition metal precursors include one or more of chloride, fluoride, iodide, sulfate, nitrate, and carbonate.

In some embodiments, the solvent includes one or more of water, ethanol, ethylene glycol, methanol, isopropyl alcohol, ether, acetonitrile and hexanol.

In some embodiments, the one or more silicate precursors includes one or more of tetra ethylene orthosilicate, sodium metasilicate, and sodium orthosilicate. In some embodiments, the one or more silicate precursors is dissolved in a silicate precursor solvent prior to addition to the transition metal mixture, the silicate precursor solvent including one or more of tetra ethylene orthosilicate, sodium metasilicate, and sodium orthosilicate.

In some embodiments, the aging is performed at a temperature of 25° C. to 80° C. for a time of 2 hours to 14 days.

In some embodiments, the drying is conducted at a temperature of 100° C. to 150° C. in vacuum oven for a time of 2 hours to 24 hours.

In some embodiments, A is 100% sodium.

In some embodiments, M¹ is one or more of titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold.

In some embodiments, M² is one or more of magnesium, zinc, calcium, beryllium, strontium, barium, aluminium and boron.

In accordance with another aspect of the present disclosure, a macroporous sodium transition metal silicate material includes a composition represented by Chemical Formula (1):

AₐM¹_{b}M²_{c}X_{d}Oₑ (1)

wherein A is sodium or a mixture of sodium with lithium and/or potassium; M¹ is one or more transition metals; M² is one or more metals and/or metalloids; X is silicon or a mixture containing silicon and one or more elements selected from phosphorus, boron and aluminium; a is >0; b is >0; c is ≧0; d is ≧1; and e is ≧2.

In some embodiments, an average pore size of the material ≧50 nm.

In some embodiments, the material includes primary particles including the composition represented by Chemical Formula (1) and having an average size of equal to or less than 300 nm. In some embodiments, the macroporous sodium transition metal silicate material further includes secondary particles including the composition represented by Chemical Formula (1), the secondary particles including an agglomeration of the primary particles, the secondary particles having an average size of 10 μm to 100 μm.

In some embodiments, the material has a surface area of ≧2 m²/g.
In some embodiments, A is 100% sodium.

In some embodiments, M¹ is one or more of titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold.

In some embodiments, M² is one or more of magnesium, zinc, calcium, beryllium, strontium, barium, aluminium and boron.

The foregoing and other features of the invention are hereinafter described in greater detail with reference to the accompanying drawings.

### BRIEF DESCRIPTION OF DRAWINGS

FIG. 1 is a flow chart showing an exemplary synthesis method for producing the sodium transition metal silicate material of the present disclosure.

FIG. 2 is an X-ray diffraction pattern of amorphous Na₂CoSiO₄ and ordered NaCl after precipitation, aging, and drying as conducted in accordance with the exemplary synthesis method of FIG. 1. X-ray diffraction pattern, 10°-70° 2θ, 0.02 degree steps, Cu Kα₁ radiation.

FIG. 3 is an X-ray diffraction pattern of ordered Na₂CoSiO₄ and ordered NaCl after annealing to 650° C. under flowing N₂, 8 hours of the aged and dried precipitate as conducted in accordance with the exemplary synthesis method of FIG. 1. X-ray diffraction pattern, 10°-70° 2θ, 0.02 degree steps, Cu Kα₁ radiation.

FIG. 4 is an X-ray diffraction pattern of ordered Na₂CoSiO₄ after washing of Na₂CoSiO₄ and NaCl product (post-annealing) with ethylene glycol followed by washing with ethanol as conducted in accordance with the exemplary synthesis method of FIG. 1. X-ray diffraction pattern, 10°-70° 2θ, 0.02 degree steps, Cu Kα₁ radiation.

FIG. 5 is a scanning electron microscopy (SEM) image of Na₂CoSiO₄ synthesized by the exemplary synthesis method of FIG. 1 showing porous agglomerates. 100 μm scale bar shown.

FIG. 6 is another SEM image of Na₂CoSiO₄ synthesized by the exemplary synthesis method of FIG. 1 with pores of approximately 50 nm to 500 nm in size. 5 μm scale bar shown.

FIG. 7 is an apparent pore size distribution of Na₂CoSiO₄ synthesized by the exemplary synthesis method of FIG. 1.

FIG. 8 is another SEM image of Na₂CoSiO₄ synthesized by the exemplary synthesis method of FIG. 1. 20 μm scale bar shown.

FIG. 9 is another SEM image of Na₂CoSiO₄ synthesized by the exemplary synthesis method of FIG. 1. 3 μm scale bar shown.

FIG. 10 is another SEM image of Na₂CoSiO₄ synthesized by the exemplary synthesis method of FIG. 1. 1 μm scale bar shown.

FIG. 11 is a scanning electron microscopy (SEM) image of Na₂CoSiO₄ synthesized by the exemplary synthesis method of FIG. 1. 4 μm scale bar shown.

FIG. 12 is a SEM image of Na₂CoSiO₄ synthesized by the exemplary synthesis method of FIG. 1 with the annealing step omitted. 100 μm scale bar shown.

FIG. 13 is another SEM image of Na₂CoSiO₄ synthesized by the exemplary synthesis method of FIG. 1 with the annealing step omitted. 10 μm scale bar shown.

FIG. 14 is another SEM image of Na₂CoSiO₄ synthesized by the exemplary synthesis method of FIG. 1 with the annealing step omitted. 5 μm scale bar shown.

FIG. 15 is a SEM image of Na₂Mn₂Si2O₇ synthesized by the exemplary synthesis method of FIG. 1 showing porous agglomerates. 20 μm graduations shown. Pore sizes of 0.1 μm to 4 μm in size are observed in the secondary particle.

FIG. 16 is another SEM image of Na₂Mn₂Si₂O₇ synthesized by the exemplary synthesis method of FIG. 1 showing porous agglomerates. 1 μm graduations shown. Primary particles of 100 nm to 250 nm are observed, with pore sizes of around 200 nm to 300 nm.

FIG. 17 is an apparent pore size distribution of Na₂Mn₂Si₂O₇ synthesized by the exemplary synthesis method of FIG. 1.

FIG. 18 is another SEM image of Na₂Mn₂Si2O₇ synthesized by the exemplary synthesis method of FIG. 1. 1 μm scale bar shown.

FIG. 19 is another SEM image of Na₂Mn₂Si2O₇ synthesized by the exemplary synthesis method of FIG. 1. 5 μm scale bar shown.

FIG. 20 is another SEM image of Na₂Mn₂Si2O₇ synthesized by the exemplary synthesis method of FIG. 1. 40 μm scale bar shown.

FIG. 21 is a SEM image of Na₂Mn₂Si2O₇ synthesized by the exemplary synthesis method of FIG. 1 with the annealing step omitted. 100 μm scale bar shown.

FIG. 22 is a SEM image of Na₂Mn₂Si2O₇ synthesized by the exemplary synthesis method of FIG. 1 with the annealing step omitted. 3 μm scale bar shown.

FIG. 23 is a voltage vs. capacity plot of Na₂CoSiO₄ used as an active material in a sodium-ion electrochemical cell. Cycled 1.5V-4V vs. Na/Na+, C/20 rate (assuming 100 mAhg-1), vs. metallic sodium, 0.5M NaClO₄ in propylene carbonate electrolyte.

### DETAILED DESCRIPTION OF INVENTION

Hereinafter, the embodiments of the present disclosure will be described with reference to the accompanying tables and figures.

The present disclosure provides a sodium transition metal silicate material. The sodium transition metal silicate material of the present disclosure may be a material having an ordered crystalline structure and a macroporous topology. More specifically, the macroporous topology may enhance the surface area of the sodium transition metal silicate material and may provide a large proportion of the sodium transition metal silicate material situated at surface sites. The macroporous topology of the sodium transition metal silicate material may facilitate insertion of reactive species within the pores. The ordered crystalline structure of the sodium transition metal silicate material may allow for the modification of reactive sites within its structure.

This synthesis method set forth in the present disclosure allows for the production of high purity sodium transition metal silicate materials. These sodium transition metal silicate materials produced from the synthesis method of the present disclosure may possess different crystal structures depending upon the target sodium transition metal. Silicon may be tetrahedrally coordinated by oxygen in these materials, and the tetrahedra units may form discrete units, dimers such as in Si₂O₇ units, chains, and/or layers. Dispersed in between the silicate units are transition metal and sodium cations.

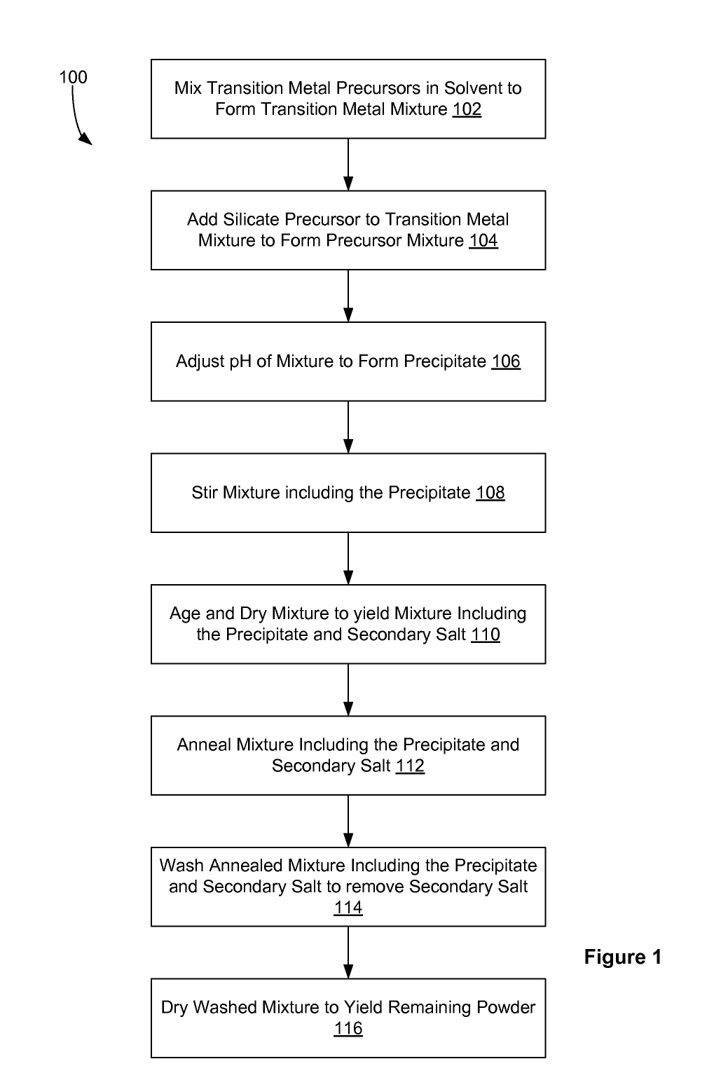

Typically silicate materials are very resistive, and in terms of an active material for a battery, small particle sizes are desired to improve the electrochemical performance properties. Small particles reduce the sodium ion diffusion path length. In accordance with the synthesis method described herein, the particle size of the sodium transition metal silicate material can be controlled by different annealing (i.e., firing) times and temperatures (e.g., as provided at step 112 in FIG. 1, described below). For example, in the materials which have been formed and then annealed to high temperatures of at least about 650° C. in accordance with the synthesis method, a crystalline material may be observed with a small primary particle size. Typical average primary particle size ranges may be equal to or less than 300 nm. These primary particles agglomerate to form larger secondary particles, with an observed macroporous topology.

Sodium transition metal silicate materials which undergo lower annealing temperatures, or that just undergo the drying step without annealing (in accordance with the synthesis method of the present disclosure), have been found to possess a very small particle size. For example, the primary particle size of such sodium transition metal silicate materials is difficult to determine by SEM imaging, but are typically less than 50 nm in size. What is observed is the presence of larger secondary particles, the larger secondary particles being formed from the agglomeration of the small primary particles. A larger inherent macroporosity can also be observed.

The porosity of a material can be described as a microporous, mesoporous or macroporous type of porosity. For example, the following porosity types may be grouped as follows:
Microporous: pore diameters of less than about 2 nm
Mesoporous: pore diameters about 2 nm to about 49 nm
Macroporous: pore diameters equal to or greater than about 50 nm

The porosity of the sodium transition metal silicate material can be controlled via the drying and annealing temperatures (e.g., as provided at steps 110 and 112 in FIG. 1, described below). Typically the sodium transition metal silicate materials of the present disclosure exhibit macroporosity, where the average size (e.g., diameter) of the pores is equal to or greater than 50 nm. With annealing, the primary particles may exhibit very low micro- and mesoporosity as determined from by Brunauer-Emmett-Teller (BET) measurements. However the macroporosity of the sodium transition metal silicate material may be observed under SEM with pores typically being in the range 50 nm-5 μm.

In some embodiments, the surface area of the sodium transition metal silicate materials produced in accordance with the synthesis method of the present disclosure may be equal to or greater than 2 m²/g is as determined from BET measurements. In other embodiments, the surface area of the sodium transition metal silicate materials produced in accordance with the synthesis method of the present disclosure may be equal to or greater than 4 m²/g.

### Sodium Transition Metal Silicate Material

The general elemental formula of the sodium transition metal silicate material of the present disclosure may be AₓM_{y}Si_{z}O_{d} where: A=an alkali metal(s) or alkali-earth metal(s); M=transition metal(s); Si=silicon; O=oxygen. The letters x, y, z, and d represent the stoichiometry of the material constituents. In some embodiments, one or more of the constituents A, M, Si, and O may be partially substituted for one or more dopants.

More specifically, the sodium transition metal silicate material of the present disclosure may be represented by Chemical Formula (1):

AₐM¹_{b}M²_{c}X_{d}Oₑ (1)

wherein

A is sodium or a mixture of sodium with lithium and/or potassium;

M¹ is one or more transition metals that are capable of undergoing oxidation to a higher valence state;

M² is one or more metals and/or metalloids;

X is silicon or a mixture containing silicon and one or more elements selected from phosphorus, boron and aluminium;

a is >0;

b is >0;

c is ≧0;

d is ≧1; and

e is ≧2.

The values of a, b, c, d, and e may be selected to maintain the electroneutrality of the compound. In some embodiments, the value of one or more of a, b, c, d, and e may be an integer (i.e., a whole number). In other embodiments, the value of one or more of a, b, c, d, and e may be a non-integer (i.e., a fraction).

In some embodiments, A is 100% sodium. In other embodiments, A is a mixture of sodium and lithium. In other embodiments, A is a mixture of sodium and potassium. In still other embodiments, A is a mixture of sodium, lithium, and potassium. In some examples the value of a, representing the amount of A, may be in the range of 0≦a≦4. In other examples, this value of a may be in the range of 1≦a≦3. In still other examples, this value of a may be in the range of 1≦a≦2.5.

In some embodiments, M¹ is one or more transition metals that are capable of undergoing oxidation to a higher valence state. Exemplary transition metals include titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold. In some examples the value of b, representing the amount of M¹, is in the range of 0<b≦5. In other examples, this value of b may be in the range of 0.25≦b≦3. In other examples, this value of b may be in the range of 0.5≦b≦2. In other examples, this value of b may be in the range of 0.5≦b≦1.

In some embodiments, M² is one or more metals and/or metalloids selected from magnesium, zinc, calcium, beryllium, strontium, barium, aluminium and boron. In some examples the value of c, representing the amount of M² is in the range of 0≦c≦1. In other examples, the value of c is in the range of 0≦c≦0.75. In other examples, the value of c is in the range of 0≦c≦0.55. In other examples, the value of c is in the range of 0.05≦c≦0.55.

In some embodiments, X is 100% silicon. In other embodiments, X is a mixture of silicon and one or more elements selected from phosphorus, boron and aluminium. In embodiments where boron and/or aluminium are included in the X_{d}Oₑ portion of the compound, then this is in addition to any boron and/or aluminium that may be included in M². In some implementations where X is a mixture of silicon and one or more of the above-described elements, the amount of silicon in X may be more than 40%, and the one or more elements selected from phosphorus, boron and aluminium may be less than 60%. In other implementations where X is a mixture of silicon and one or more of the above-described elements, the amount of silicon in X may be in the range of 80%-99.9%. In some examples the value of d, representing the amount of X is in the range of 1≦d≦8. In other examples, the value of d is in the range of 2≦d≦8. In other examples, the value of d is in the range of 1≦d≦2. In other examples, the value of d is 2.

In some embodiments the value of e, representing the amount of oxygen, is in the range of 2≦e≦24. In other embodiments, this value of e is in the range of 2≦e≦8. In other embodiments, this value of e is in the range of 2≦e≦6. In other embodiments, this value of e is in the range of 6≦e≦8.

In some embodiments, X_{d}Oₑ is a silicate group that is selected from SiO₄, and condensed silicate polyanions including Si₂O₆, Si₂O₇, Si₂O₈, Si₈O₂₄, Si₃O_{12′}. More specifically, embodiments of X_{d}Oₑ may include SiO₄, Si₂O₆, Si₂O₇.

Exemplary sodium transition metal silicate materials of the present disclosure include:

Na₂M¹SiO₄, where M¹=one or more of Mn, Co, Fe, and Ni
Na₂Mn_{0.5}Fe_{0.5}SiO₄
Na₂Fe₁₋ₓMgₓSiO₄
Na₂Fe_{0.95}Mg_{0.05}SiO₄
Na₂Fe_{0.9}Mg_{0.1}SiO₄
Na_{1.8}Mg_{0.1} FeSiO₄
Na₂Fe_{0.9}Al_{0.05}Li_{0.05}SiO₄
Na₂Ti_{0.45}Zn_{0.55}SiO₄
Na₂FeSi₂O₆
Na₂Ni₂Si₂O₇
Na_{2.5}V_{0.5}Si₂O₆
Na₂M¹₃Si₂O₈ where M¹=Cu, Mn, Co, Ni or Fe
Na₂M¹₂Si₂O₇, where M¹=Cu, Mn, Co, Ni or Fe
Na_{2.1}Mn_{1.9}Si₂O₇
Na₃M¹Si₂O₇, where M¹=one or more of V, Mn, and Cr
Na₂M¹Si₂O₆, where M¹=one or more of Mn, Co, Ni, and Fe
NaM¹Si₂O₆, where M¹=one or more of Mn, Fe, Mo, V, Cr, Y, and Ti
NaV_{0.5}Al_{0.5}Si₂O₆
NaV_{0.75}Al_{0.25}Si₂O₆
NaV_{0.5}Y_{0.5} Si₂O₆
NaV_{0.75}Ti_{0.1875}Si₂O₆
NaV_{0.5}Ti_{0.375}Si₂O₆
NaV_{0.75}B_{0.25}Si₂O₆
NaV_{0.5}B_{0.5}Si₂O₆
NaYSi₂O₆
NaV_{0.25}Ti_{0.5625}Si₂O₆
NaV_{0.125}Ti_{0.6563}Si₂O₆
NaV_{0.5}Cr_{0.5}Si₂O₆
NaV_{0.25}Cr_{0.75}Si₂O₆
NaTiSi₂O₆
NaV_{0.5}Ti_{0.5}Si₂O₆
NaV_{0.75}Si₂O₆
NaV_{0.5}Si₂O₆
Na_{2.5}M¹Si₂O₆, where M¹=one or more of V, Fe, Cr, Mn, and Ni
Na₂M¹₃Si₂O₈, where M¹=one or more of Mn, Co, Ni, and Fe
Na₃M¹₅Si₈O₂₄, where M¹=one or more of Mn, Co, Fe, and Ni
Na_{1.8}M¹Si_{0.8}P_{0.2}O₄, where M¹=+2 oxidation state metal
Na_{1.5}M¹Si_{0.5}P_{0.5}O₄, where M¹=+2 oxidation state metal
Na_{1.6}M¹₂Si_{1.6}P_{0.4}O₇, where M¹=+2 oxidation state metal
Na_{1.8}M¹₂Si_{1.8}P_{0.2}O₇, where M¹=+2 oxidation state metal
Na_{2.2}M¹Si_{0.8}B_{0.2}O₄, where M¹=+2 oxidation state metal
Na_{2.4}M¹Si_{0.6}Al_{0.4}O₄, where M¹=+2 oxidation state metal

Examples of suitable +2 oxidation state metals for the above examples include one or more of Cu, Zn, Mg, V, Cr, Mn, Fe, Co, and Ni.

The sodium transition metal silicate materials of the present disclosure may be provided as a macroporous bulk material including primary and secondary particles. The primary particles may be small particles, and the secondary particles may be agglomerations of the primary particles. In some embodiments, the average size of the primary particles may be equal to or less than 300 nm. In other embodiments, the average size of the primary particles may be equal to or less than 200 nm. In other embodiments, the average size of the primary particles may be 20 nm to 200 nm. In other embodiments, the average size of the primary particles may be equal to or less than 50 nm. In other embodiments, the average size of the primary particles may be less than 10 nm.

The size of the primary particles may depend upon the conditions of the drying and annealing as performed in the synthesis method of the present disclosure. As an example, materials which were dried at 120° C. and not annealed to higher temperatures are much smaller in average particle size (e.g., less than 10 nm), compared to those which have been synthesised at higher temperatures. At higher temperatures and longer annealing times the primary particles undergo Oswald ripening and the primary particles grow in size at the expense of smaller particles, and sinter.

The meso- and microporosity of the materials is dependent upon the primary particle size, and the sintering of smaller particles into larger particle sizes. At lower temperatures where sintering does not occur, the micro- and mesoporosity is dependent upon the primary particle size and the size of the gaps between the primary particles. At higher temperatures where sintering occurs, the micro- and mesoporosity disappears or becomes negligible.

What is observed in the sodium transition metal silicate materials of the present disclosure is the macroporosity in the secondary particles. The macroporosity is caused by the crystallization of the secondary salt in the synthesis method (described below), and the pore size in the secondary particles is related to this crystallization. The primary particles agglomerate around the salt which crystallizes during the drying step of the synthesis method (described below). After drying and any post treatment, the crystallized salt is washed away (described below) and a macroporous secondary particle is observed. This secondary particle structure is a 3-D network of agglomerated primary particles with a macroporous structure. In some embodiments, the secondary particles have an average size (i.e., diameter) of 1 μm to 200 μm. In other embodiments, the secondary particles have an average size (e.g., diameter) of 10 μm to 100 μm. In other embodiments, the secondary particles have an average size (i.e., diameter) of 50 μm to 100 μm.

In some embodiments, the sodium transition metal silicate materials of the present disclosure may be embodied as a porous catalyst for use in connection with one or more catalytic reactions. Exemplary catalytic reactions include, but are not limited to, hydrogenation reactions, cracking of petroleum derived compounds, Fischer-Tropsch synthesis, hydrodesulphurisation, and hydroformylation. The sodium transition metal silicate materials of the present disclosure may be embodied as the active material in such catalytic reactions.

In other embodiments, the sodium transition metal silicate materials of the present disclosure may be embodied as part of an electrode (e.g., a cathode).

The sodium transition metal silicate material may form an active element of the electrode. Exemplary sodium transition metal silicate materials in accordance with the present disclosure that may be used as the active element in the electrode include:

Na₂M¹SiO₄, where M¹=one or more of Mn, Co, Fe, and Ni
Na₂Mn_{0.5}Fe_{0.5}SiO₄
Na₂Fe₁₋ₓMgₓSiO₄
Na₂Fe_{0.95}Mg_{0.05}SiO₄
Na₂Fe_{0.9}Mg_{0.1}SiO₄
Na_{1.8}Mg_{0.1} FeSiO₄
Na₂Fe_{0.9}Al_{0.05}Li_{0.05}SiO₄
Na₂Ti_{0.45}Zn_{0.55}SiO₄
Na₂FeSi₂O₆
Na₂Ni₂Si₂O₇
Na_{2.5}V_{0.5}Si₂O₆
Na₂M¹₃Si₂O₈ where M¹=Cu, Mn, Co, Ni or Fe

Other exemplary sodium transition metal silicate materials in accordance with the present disclosure that may be used as the active element in the electrode include:

Na₂M¹₂Si₂O₇, where M¹=Mn, Co, Ni or Fe
Na_{2.1}Mn_{1.9}Si₂O₇
Na₃M¹Si₂O₇, where M¹=one or more of V, Mn, Cr, and Ni
Na₂M¹Si₂O₆, where M¹=one or more of Mn, Co, Ni, and Fe
NaM¹Si₂O₆, where M¹=one or more of Mn, Fe, Mo, V, Cr, Y, Ti, and Ni
NaV_{0.5}Al_{0.5}Si₂O₆
NaV_{0.75}Al_{0.25}Si₂O₆
NaV_{0.5}Y_{0.5} Si₂O₆
NaV_{0.75}Ti_{0.1875}Si₂O₆
NaV_{0.5}Ti_{0.375}Si₂O₆
NaV_{0.75}B_{0.25}Si₂O₆
NaV_{0.5}B_{0.5}Si₂O₆
NaYSi₂O₆
NaV_{0.25}Ti_{0.5625}Si₂O₆
NaV_{0.125}Ti_{0.6563}Si₂O₆
NaV_{0.5}Cr_{0.5}Si₂O₆
NaV_{0.25}Cr_{0.75}Si₂O₆
NaTiSi₂O₆
NaV_{0.5}Ti_{0.5}Si₂O₆
NaV_{0.75}Si₂O₆
NaV_{0.5}Si₂O₆
Na_{2.5}M¹Si₂O₆, where M¹=one or more of V, Fe, Cr, Mn, and Ni
Na₂M¹₃Si₂O₈, where M¹=one or more of Mn, Co, Ni, and Fe
Na₃M¹₅Si₈O₂₄, where M¹=one or more of Mn, Co, Fe, and Ni
Na_{1.8}M¹Si_{0.8}P_{0.2}O₄; where M¹=+2 oxidation state metal
Na_{1.5}M¹Si_{0.5}P_{0.5}O₄; where M¹=+2 oxidation state metal
Na_{1.6}M¹₂Si_{1.6}P_{0.4}O₇; where M¹=+2 oxidation state metal
Na_{1.8}M¹₂Si_{1.8}P_{0.2}O₇; where M¹=+2 oxidation state metal
Na_{2.2}M¹Si_{0.8}B_{0.2}O₄; where M¹=+2 oxidation state metal
Na_{2.4}M¹Si_{0.6}Al_{0.4}O₄; where M¹=+2 oxidation state metal

Examples of suitable +2 oxidation state metals for the above examples include one or more of Cu, Zn, Mg, V, Cr, Mn, Fe, Co, and Ni.

In some embodiments, the electrode including the sodium transition metal silicate materials in accordance with the present disclosure may be utilized as part of an energy storage device. The energy storage device may be suitable for use as one or more of the following: A sodium ion and/or lithium ion and/or potassium ion cell; a sodium metal and/or lithium metal and/or potassium metal ion cell; a non-aqueous electrolyte sodium ion and/or lithium ion and/or potassium ion cell; an aqueous electrolyte sodium ion and/or lithium ion and/or potassium ion cell.

Examples of energy storage devices include a battery, a rechargeable battery, an electrochemical device, and an electrochromic device. Further examples include a sodium ion battery or other electrical energy storage device, including large scale grid level electrical energy storage systems or devices.

The sodium transition metal silicate materials according to the present disclosure may be prepared using the following exemplary synthesis method:

### Synthesis Method

FIG. 1 is a flow chart showing an exemplary synthesis method for producing a sodium transition metal silicate material in accordance the present disclosure. The synthesis method 100 shown in FIG. 1 may yield a high surface area, macroporous sodium transition metal silicate material of the formula AₐM¹_{b}M²_{c}X_{d}Oₑ, as described above. The exemplary synthesis method 100 may be characterized as a modified co-precipitation technique.

At step 102, transition metal precursor materials are mixed in a solvent. Mixing of the transition metal precursor materials in the solvent results in the transition metal precursor materials becoming dissolved and/or dispersed in the solvent. The dissolved and dispersed transition metal precursor materials within the solvent form a transition metal mixture. Exemplary transition metal precursors include one or more transition metal salts such as chloride, fluoride, iodide, sulfate, nitrate, and carbonate. These precursor transition metal salts may be chosen so that a soluble secondary salt is formed later in the synthesis method (e.g., during step 110). In some embodiments, the precursor salts may be dissolved in a solvent such as water. In other embodiments, alternative or additional solvents such as ethanol, ethylene glycol, methanol, isopropyl alcohol, ether, acetonitrile or hexanol may be used wholly or in part as the solvent. In some embodiments, the transition metal mixture may be stirred for 2 minutes to 12 hours. In other embodiments, the transition metal mixture may be stirred for 30 minutes to 2 hours. In some embodiments, the mixing may be conducted at room temperature (e.g., at about 25° C.). In other embodiments, the mixing may be conducted at an elevated temperature (e.g., about 26° C. to about 80° C.). The elevated temperature may be lower than that of the boiling point of the solvent or may be under reflux conditions if higher than the boiling point of the solvent.

At step 104, silicate precursor is added to the transition metal mixture formed in step 102. The silicate precursor may be added directly to the transition metal mixture or may be pre-dissolved in a solvent. Exemplary silicate precursor materials include tetra ethylene orthosilicate (TEOS), sodium metasilicate, sodium orthosilicate. Typically for TEOS precursors, ethanol may be used as a solvent. For sodium silicate precursors, water may be used. Other solvents such as ethylene glycol, methanol, isopropyl alcohol, ether, acetonitrile, or hexanol may be used wholly or in part as the solvent for the silicate precursor. The silicate precursor (either alone or as mixed with the solvent) may be mixed with the transition metal mixture and may be stirred until homogeneous so as to form the precursor mixture. An additional quantity of acid may be added at this stage to initiate hydrolysis of the silicate. Typically nitric acid (e.g., 5M nitric acid) may be used, however other acids such as HCl, HNO₃, H2SO₄, and acetic acid may be used. In some embodiments, the precursor mixture may be stirred for 2 minutes to 12 hours. In other embodiments, the precursor mixture may be stirred for 30 minutes to 2 hours. The mixing may be conducted at room temperature (e.g., at about 25° C.), or in other embodiments may be conducted at an elevated temperature (e.g., about 26° C. to about 80° C.). The elevated temperature may accelerate the hydrolysis of the silicate precursor.

At step 106, the pH of the precursor mixture is adjusted (e.g., raised) using a base (e.g., one or more of sodium hydroxide, ammonium hydroxide, lithium hydroxide, and potassium hydroxide), until precipitation occurs. The precipitate formed at step 106 may be a co-precipitation of the silicate and the transition metal cations. As an example, the precipitate may include an oxide or a hydroxide, and may include a sodium compound. Alternatively or in addition, in some embodiments, the precipitation may include the sodium transition metal silicate. If the sodium transition metal silicate is formed directly as the precipitate, this may result in formation in at least a portion of the primary particles. For the co-precipitation of the silicate and transition metal cations, the primary particles may be subsequently formed (e.g., during aging/drying and annealing). The precipitate may start to form around pH 5.5, and the particle size of this precipitate can be controlled by raising the pH up to pH 14. The higher the pH, the smaller the particle size may be. In some embodiments, the pH may be raised to a range pH 6 to pH 10. In other embodiments, the pH may be raised to a range pH 7 to pH 8.

At step 108, the mixture including the precipitate is stirred for a prescribed period of time. Stirring may further facilitate formation of the precipitate. In some embodiments, the stirring is conducted at room temperature (e.g., at about 25° C.). In other embodiments, the stirring is conducted at an elevated temperature (e.g., about 26° C. to about 80° C.), such temperature being lower than that of the boiling point of the solvent, or under reflux conditions if higher than the boiling point of the solvent. As an example, the temperature may be 26° C. to 80° C. for a water/ethanol based solvent. In some embodiments, stirring may be performed for 30 minutes to 24 hours. In other embodiments, stirring may be performed for 1 hour to 12 hours.

At step 110, the stirred mixture including the precipitate is aged and dried. The aging may be performed at room temperature, or at a temperature below the boiling point of the solvent. As an example, the aging temperature may be 25° C. to 80° C. This aging may be conducted for a time period of 2 hours to 14 days. Aging of the co-precipaitation may facilitate a condensation reaction among the precipitate. As an example, a condensation reaction may occur with the silicate, the water, and the metal cations to form a network. This may initiate formation of the primary particles. The drying may be conducted in a vacuum oven or in air or inert atmosphere (e.g., in a nitrogen atmosphere). The drying step removes the solvent from the aged mixture and may facilitate crystallization of secondary salts. The aged and dried mixture may therefore include the precipitate and the secondary salts. In one example, the drying may be conducted at a temperature of 100° C. to 150° C. in vacuum oven for a time of 2 hours to 24 hours. In another example, the drying may be conducted at 120° C. in a vacuum oven for a time of 2 hours to 24 hours.

The secondary salts formed in step 110 may be sodium salts, or other base salts, determined by the precursors in step 102, and step 106. For example, if transition metal chloride salts are used, the formed secondary salt may be sodium chloride. If transition metal sulfate salts and sodium hydroxide are used, the formed secondary salt may be sodium sulfate. If transition metal nitrate salts are used, the formed secondary salt may be sodium nitrate. The size of the secondary salt crystallites depends upon the aging and the drying temperatures and times. For example, large crystals of the secondary salts may form with long aging times and low drying temperatures, and small crystals of the secondary salts may form with fast aging and drying times.

At step 112, the aged and dried mixture including the precipitate and the secondary salts is annealed. Annealing may be conducted at temperatures of 120° C. to 1000° C. for a time of 10 minutes to 12 hours. This annealing results in the formation of a desired phase (including the transition metal silicate material) and a secondary soluble phase (including the secondary salt), or may improve the crystallinity of the desired phase if it is produced directly in step 106/108. The primary particle size of the sodium transition metal silicate material may be controlled by different annealing times and temperatures. For example, lower annealing temperatures and lower annealing times will typically yield sodium transition metal silicate materials with smaller primary particle sizes, compared to sodium transition metal silicate materials which were annealed at high temperatures for long period of times. These primary particles may agglomerate to form larger secondary particles.

In some embodiments of the synthesis method of the present disclosure, the annealing step is not conducted. Accordingly, step 112 may be omitted from the synthesis method.

At step 114, the mixture including the precipitate and the one or more secondary salts (e.g., the annealed mixture or the aged and dried mixture) is washed in a solvent to remove the secondary salt. The solvent may be one or more of water, ethanol, acetone, isopropyl alcohol (IPA), hexanol, ethylene glycol, acetonitrile, and hexane. The solvent may be chosen such that the secondary salt is soluble in the solvent, and the sodium transition metal silicate is not. Hence, washing the mixture may result in the secondary salt being dissolved in the solvent. In some embodiments, the mixture may be washed multiple times using multiple solvents i.e., the same type of solvent or different types of solvents.

At step 116, the washed mixture is dried and the solvent is removed to yield the remaining powder. Drying may typically be performed in a vacuum oven at an elevated temperature for a predetermined period of time. In one example, the drying may be conducted at a temperature of 100° C. to 150° C. in vacuum oven for a time of 2 hours to 24 hours. In another example, the drying may be conducted at 120° C. in vacuum oven for 2 hours to 24 hours.

Using the above representative synthesis method, several exemplary materials were prepared. These exemplary materials are summarized in Table 1. In all cases in which the materials were prepared in accordance with the synthesis method of the present disclosure, the sodium chloride (i.e., secondary salt) was washed out using ethylene glycol as the solvent, followed by a subsequent washing in ethanol.

It is noted, however, that Example 1a is a comparative material made using a conventional solid state synthesis method. In accordance with the solid state synthesis method, the precursor materials, sodium silicate, and cobalt oxides were milled using a ball mill for 1 hour at 400 rpm. The milled materials were pressed into a pellet and fired to 850° C. under nitrogen using a slow ramp rate and cool rate of 1° C./min. It is noted that materials that are made by the solid state synthesis method require the use high temperature to aid the solid state diffusion of the ions. Lower temperature synthesis leads to impure materials. As compared with the conventional solid state synthesis method, the synthesis method of the present disclosure can form the materials at lower temperatures due to the intimate mixing of the ions at a much smaller length scale.

It is further noted that Examples 1b and 5b are examples in which the solvent was removed at 120° C. (step 110), but annealing is not conducted (i.e., step 112 is not performed). The mixture was washed with ethylene glycol (step 114) and dried (step 116).

TABLE 1
Summary of exemplary sodium transition metal silicate materials
produced using the exemplary synthesis method of FIG. 1

| | TARGET | | | FURNACE |
|---|---|---|---|---|
| EXAM- | COM- | STARTING | SOLVENT | CONDI- |
| PLE | POUND | MATERIALS | (step 102) | TIONS |
| 1 | Na₂CoSiO₄ | Si(OC₂H₅)₄, | DI water & | 650° C., |
| | | CoCl₂, NaOH | ethanol | 8 hrs, N₂ |
| | | | (5:1 vol.) | |
| 1a | Na₂CoSiO₄ | Na2SiO4, CoO | N/A - Produced | 850° C., |
| | | | via Solid State | 8 hrs, N₂ |
| | | | method | |
| 1b | Na₂CoSiO₄ | Si(OC₂H₅)₄, | DI water & | 120° C., |
| | | CoCl₂, NaOH | ethanol | 12 hrs, |
| | | | (5:1 vol.) | Vacuum |
| 2 | Na₂MnSiO₄ | Si(OC₂H₅)₄, | DI water & | 650° C., |
| | | MnCl₂, NaOH | ethanol | 8 hrs, N₂ |
| | | | (5:1 vol.) | |
| 3 | Na₂FeSiO₄ | Si(OC₂H₅)₄, | DI water & | 650° C., |
| | | FeCl₂, NaOH, | ethanol | 8 hrs, N₂ |
| | | sucrose | (5:1 vol.) | |
| 4 | Na₂Co₂Si₂O₇ | Si(OC₂H₅)₄, | DI water & | 600° C., |
| | | CoCl₂, NaOH | ethanol | 8 hrs, N₂ |
| | | | (5:1 vol.) | |
| 5 | Na₂Mn₂Si₂O₇ | Si(OC₂H₅)₄, | DI water & | 650° C., |
| | | MnCl₂, NaOH | ethanol | 8 hrs, N₂ |
| | | | (5:1 vol.) | |
| 5b | Na₂Mn₂Si₂O₇ | Si(OC₂H₅)₄, | DI water & | 120° C., |
| | | MnCl₂, NaOH | ethanol | 12 hrs, |
| | | | (5:1 vol.) | Vacuum |
| 6 | Na₂NiMnSi₂O₇ | Si(OC₂H₅)₄, | DI water & | 650° C., |
| | | NiCl₂, MnCl₂, | ethanol | 8 hrs, N₂ |
| | | NaOH | (5:1 vol.) | |
| 7 | Na₂Fe₂Si₂O₇ | Si(OC₂H₅)₄, | DI water & | 650° C., |
| | | FeCl₂, NaOH, | ethanol | 8 hrs, N₂ |
| | | sucrose | (5:1 vol.) | |
| 8 | Na₂CoSi₂O₆ | Si(OC₂H₅)₄, | DI water & | 650° C., |
| | | CoCl₂, NaOH | ethanol | 8 hrs, N₂ |
| | | | (5:1 vol.) | |
| 9 | Na₂MnSi₂O₆ | Si(OC₂H₅)₄, | DI water & | 650° C., |
| | | MnCl₂, NaOH | ethanol | 8 hrs, N₂ |
| | | | (5:1 vol.) | |
| 10 | Na₂FeSi₂O₆ | Si(OC₂H₅)₄, | DI water & | 500° C., |
| | | FeCl₂, NaOH, | ethanol | 8 hrs, N₂ |
| | | sucrose | (5:1 vol.) | |
| 11 | Na₂NiSi₂O₆ | Si(OC₂H₅)₄, | DI water & | 650° C., |
| | | NiCl₂, NaOH | ethanol | 8 hrs, Air |
| | | | (5:1 vol.) | |

### Exemplary Procedure to Make a Sodium Metal Electrochemical Test Cell:

Electrochemical cells were prepared for use in connection with conventional electrochemical testing techniques. The electrochemical cells included an anode and a cathode, which were separated by an electrolyte. The anode was a sodium metal anode. The cathode was the material as prepared in accordance with the synthesis method of the present disclosure. The two electrodes sandwiched a separator layer which was soaked in electrolyte. The electrolyte was provided as a solution of NaClO₄ in propylene carbonate (PC). In some embodiments, the electrolyte was provided as a 0.5 M solution of NaClO₄ in PC. In other embodiments, the electrolyte was provided as a 1.0 M solution of NaClO₄ in PC. In some embodiments, a glass fiber separator was interposed between the positive and negative electrodes forming the electrochemical test cell. One example of a suitable glass fibre separator is a Whatman grade GF/A separator. In other embodiments, a porous polypropylene separator wetted by the electrolyte was interposed between the positive and negative electrodes forming the electrochemical test cell. One example of a suitable porous polypropylene separator is Celgard 2400. In the Examples a glass fibre separator was used.

Materials to be tested were provided as a powdered cathode electrode, a pressed pellet cathode electrode, or as a cast cathode electrode.

To prepare a cast cathode electrode including the sodium transition metal silicate material, the sample was prepared from a slurry using a solvent-casting technique. For example, to test each of the sodium transition metal silicate materials prepared in the Examples as set forth in Table 1 as the active material of the electrode, the slurry contained one of the respective sodium transition metal silicate materials prepared in Examples 1 to 11, conductive carbon, binder, and solvent. The conductive carbon used in the slurry was Super P C65, manufactured by Timcal. The binder used in the slurry was polyvinylidene fluoride (PVdF) (e.g. Kynar, manufactured by Arkema). The solvent used in the slurry was N-Methyl-2-pyrrolidone (NMP), Anhydrous, manufactured by Sigma Aldrich. The slurry was then cast onto an aluminium current collector using the Doctor-blade technique. The formed cast electrode was then dried under Vacuum at about 80° C. to 120° C. for 2 hours to 12 hours. As formed, each electrode film contained the following components, expressed in percent by weight: 75% active material, 18% Super P carbon, and 7% Kynar binder. Optionally, this ratio can be varied i.e., by adjusting the amounts of the components in the slurry, to optimize the electrode properties such as, adhesion, resistivity and porosity. Typically, cells were symmetrically charged and discharged galvanostatically at a rate of 5 mA/g-10 mA/g (current density).

The sodium transition metal silicate materials in accordance with the present disclosure can also be tested as a powdered cathode electrode. In such embodiments, the sodium transition metal silicate material can be mixed with a conductive additive, for example, by hand mixing or in a ball mill. For example, to test each of the sodium transition metal silicate material prepared in the Examples set forth in Table 1, the respective sodium transition metal silicate material prepared in one of Examples 1 to 11 was mixed with Super P C65 conductive carbon, manufactured by Timcal. The resultant electro-active mixture contains the following components, expressed in percent by weight: 80% active material, 20% Super P carbon. This ratio can be varied to optimize the properties of the mixture such as, resistivity and porosity. Typically, cells were symmetrically charged and discharged galvanostatically at a rate of 5 mA/g-10 mA/g (current density).

Alternatively, the sodium transition metal silicate materials in accordance with the present disclosure can be tested as a pressed pellet cathode electrode. In such embodiments, the sodium transition metal silicate material can be mixed with a conductive additive and a polymer binder, for example, by hand mixing or in a ball mill, this mixture is pressed into a pellet using a press. For example, to test each of the sodium transition metal silicate material prepared in the Examples set forth in Table 1, the respective sodium transition metal silicate material prepared in one of Examples 1 to 11 was mixed with Super P C65 conductive carbon (manufactured by Timcal) and with PVdF binder (manufactured by Arkema). The resultant electro active mixture contains the following components, expressed in percent by weight: 80% active material, 10% Super P Carbon, and 10% binder. This ratio can be varied to optimize the properties of the mixture such as, resistivity, porosity and wetting behaviour of the pellet. The mixture can then be pressed into a desired shape in order to form the pressed pellet. Typically, cells were symmetrically charged and discharged galvanostatically at a rate of 5 mA/g-10 mA/g (current density).

### Cell Testing:

Electrochemical cells of the example materials identified in Table 1 and prepared according to the procedures outlined above were tested using Constant Current Cycling Techniques. The cell was cycled at a current density of 5 mA/g-10 mA/g between pre-set voltage limits as deemed appropriate for the material under test. The voltage limits used to test these materials were optimized for the different tested materials. Initially, a constant current scan was performed from open circuit voltage (OCV) to 4.6 V vs. Na/Na+ and suitable voltage limits chosen for subsequent cells. The precise voltage limits depend upon the material, the redox active transition metal, and the crystal structure. Typically, voltage ranges of 1.5 V to 4.2 V vs. Na/Na+ were used initially for most materials. For iron based materials, lower voltage limits were used, typically 1 V to 2.5 V vs. Na/Na+. A commercial battery cycler from Maccor Inc. (Tulsa, Okla., USA) was used for the testing. Cells were charged symmetrically between the upper and lower voltage limits at a constant current density. On charge sodium ions are extracted from the sodium transition metal silicate cathode material and migrate to the sodium metal anode. On discharge the reverse process occurs and Sodium ions are re-inserted into the cathode material.

### Structural Characterisation:

All of the product materials were analyzed by X-ray diffraction techniques using a Bruker D2 phaser powder diffractometer (fitted with a Lynxeye™ detector) to confirm that the desired target materials had been prepared, to establish the phase purity of the products, and to determine the types of impurities present. From this information it is possible to determine the unit cell lattice parameters.

The operating conditions used to obtain the powder X-ray diffraction patterns illustrated, are as follows:

### Range: 2θ=10°-90°

### X-ray Wavelength=1.5418 Å (Angstoms) (Cu Kα)

Step size: 2θ=0.02
Speed: 1.5 seconds/step
Diffraction patterns were collected using sample holders which could allow measurement of diffraction under an inert atmosphere. The sample holder contributes to the observed diffraction patterns with large peaks centered at ca. 32°=2θ and ca. 50°=2θ and other smooth peak features can also be observed.

### Test Examples

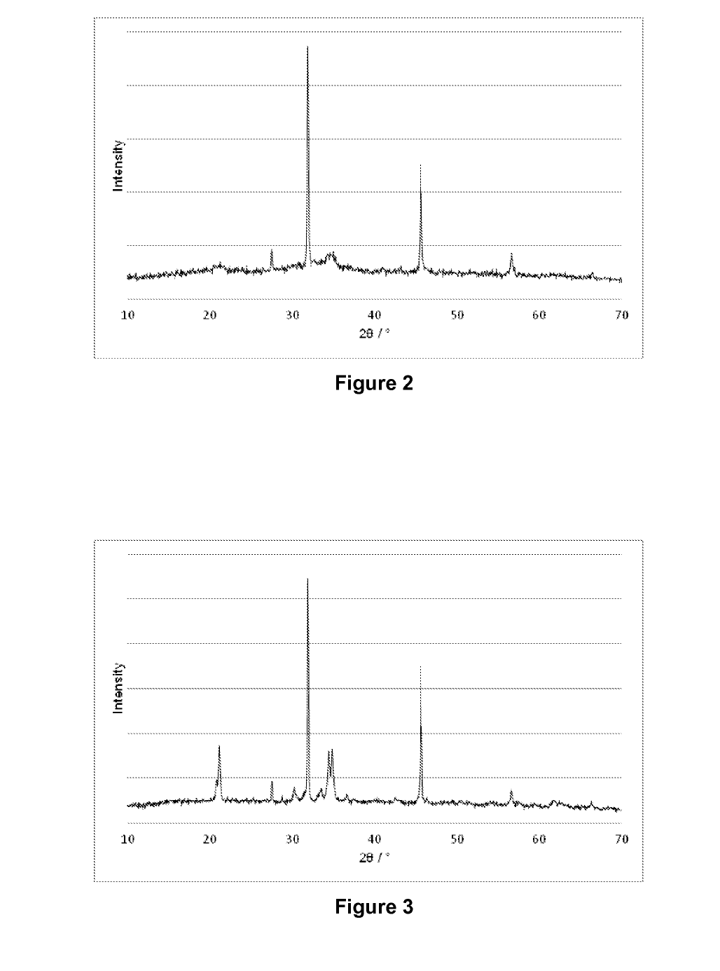

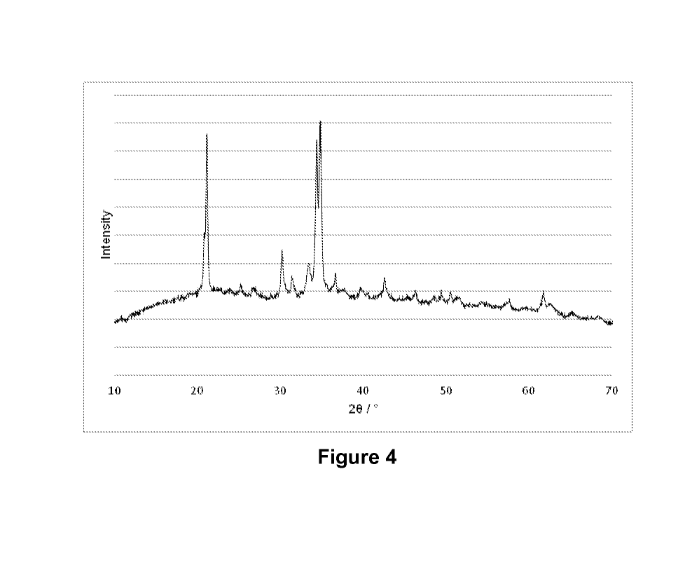

As described above, the sodium transition metal silicate material of the present disclosure may be produced in accordance with the exemplary synthesis method shown in FIG. 1. Evidence of the various stages of this exemplary synthesis route to the sodium transition metal silicate material is presented in FIGS. 2-4, which show X-ray diffraction patterns at different stages of the synthesis method for Example 1 listed in Table 1, the sodium transition metal silicate material having the formula Na₂CoSiO₄. More specifically, FIG. 2 is an X-ray diffraction pattern of amorphous Na₂CoSiO₄ and ordered NaCl after the step of aging and drying to yield a mixture including the precipitate and secondary salt (FIG. 1, step 210). FIG. 3 is an X-ray diffraction pattern of ordered Na₂CoSiO₄ and ordered NaCl after annealing the dried precipitate to 650° C. under flowing N₂ for 8 hours (FIG. 1, step 212). FIG. 4 is an X-ray diffraction pattern of ordered Na₂CoSiO₄ after washing of Na₂CoSiO₄ and NaCl product with ethylene glycol followed by ethanol (FIG. 1, step 214).

The peaks in FIG. 2 at approximately 32 2θ/°, 46 2θ/°, and 58 2θ/° relate to the cubic structure of NaCl. The remaining material is not apparent in the X-ray diffraction pattern because it is of low crystallinity or amorphous, and as a result, there is no periodic crystal ordering which can diffract the x-rays. The broad peaks observed at 22 2θ/° and 33 2θ/° relate to the sodium transition metal material Na₂CoSiO₄. When this material from step 210 is heated up to higher temperatures (step 212), the particles sizes increase and the peaks relating to the sodium transition metal phase can be observed. This is shown in FIG. 3 with the Na₂CoSiO₄ in addition to the NaCl peaks. The NaCl is separated from the transition metal silicate in step 214, and the x-ray diffraction pattern shows a very high purity Na₂CoSiO₄ with no remaining NaCl crystallites present in the x-ray diffraction trace (as shown in FIG. 4).

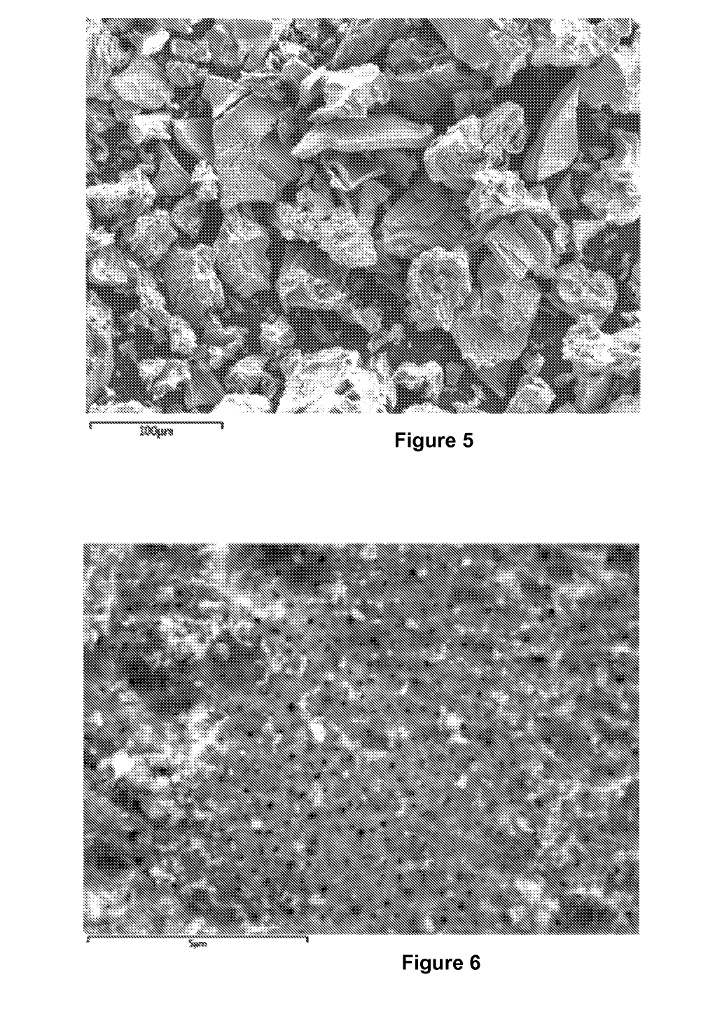

FIGS. 5 and 6 show scanning electron microscopy (SEM) images of the material of Example 1, having the formula of Na₂CoSiO₄ and produced in accordance with the exemplary synthesis method shown in FIG. 1. These images clearly show the macroporous morphology of the material. The particles observed in FIG. 5 show the large secondary particles of approximately 50 to 100 μm in size. The large secondary particles are made of macro porous agglomerations of smaller nanometer-sized primary particles. FIG. 6 shows a secondary particle at higher resolution. The dark spots in the SEM relate to pores within the material and the grey mass relates to agglomerations of the primary particle size.

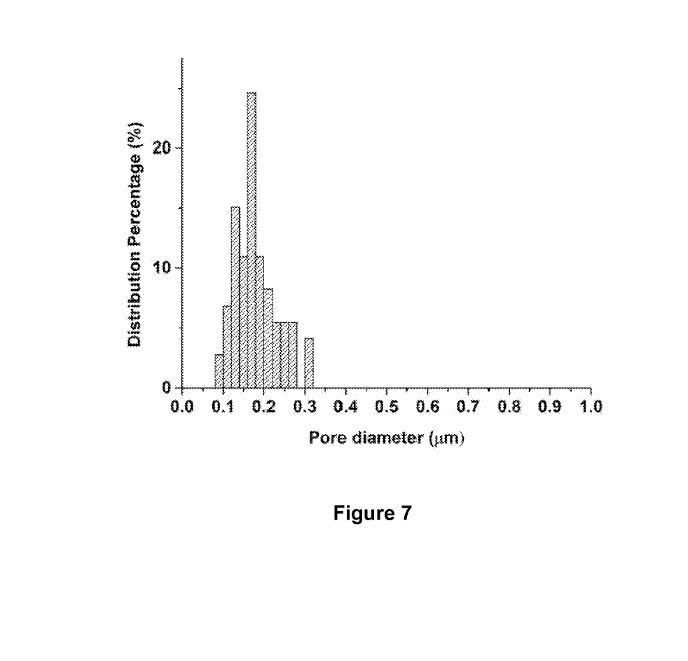

The apparent pore size distribution of the material of Example 1 is shown in FIG. 7. The apparent pore size distribution was taken by measurement of observed porous structures in the sample. Measurements were taken of the longest judged diameter of each pore from the calibrated Scanning Electron micrographs. As shown, the macroporous Na₂CoSiO₄ has a measured range of pore sizes between 0.05 μm and 0.35 μm, with 25% of pores in between 0.16 μm and 0.18 μm.

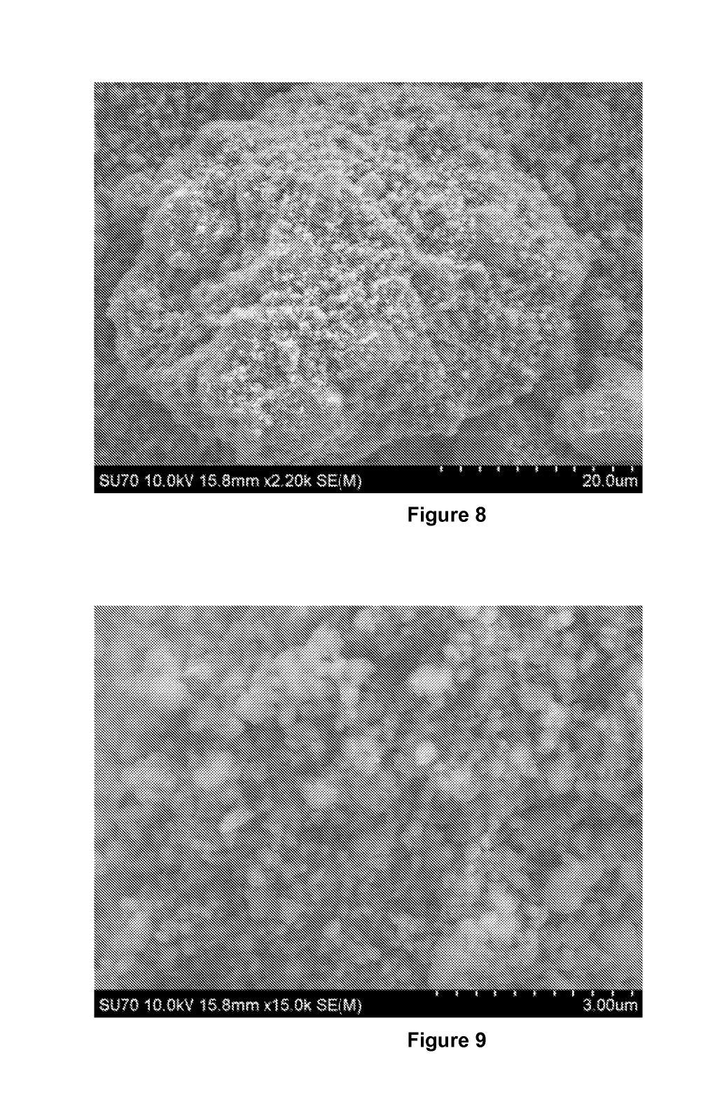

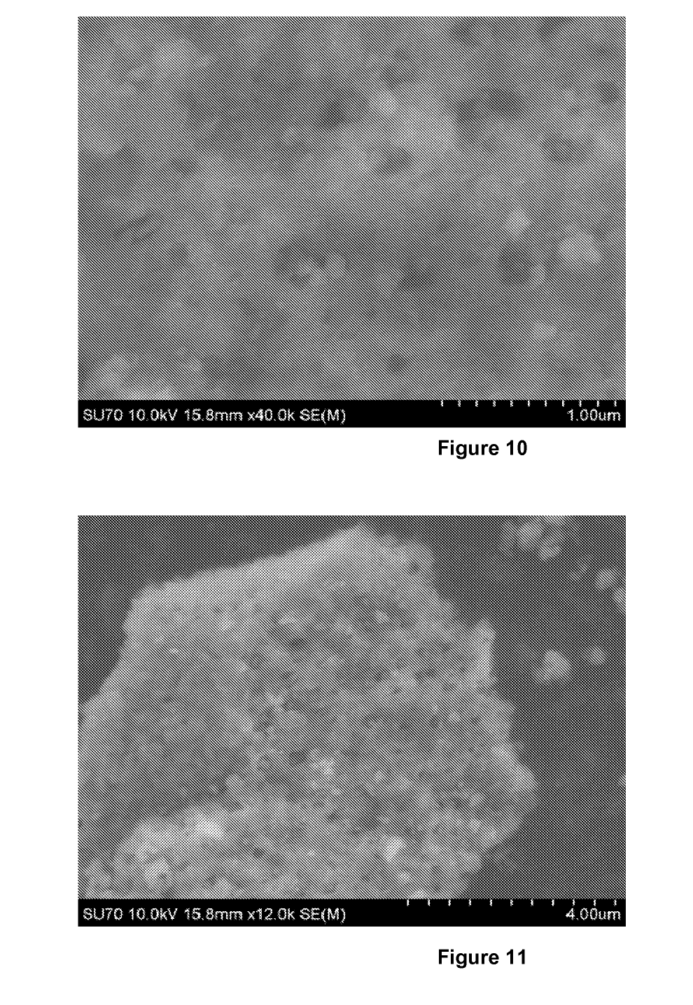

FIGS. 8-11 show other SEM images of the material of Example 1, having the formula of Na₂CoSiO₄ and produced in accordance with the exemplary synthesis method shown in FIG. 1. The SEM pictures in FIGS. 8-11 show that there are large agglomerations of particles (FIG. 8) which are made from smaller primary particles. These primary particles are typically less than 300 nm in size (FIG. 9). On closer inspection of the secondary particles, there can be seen a large macroporosity with pore sizes ranging up to approximately 500 nm (FIGS. 10 and 11). These SEM graphs clearly illustrate the large secondary particles, that are formed of the smaller primary particles, the large secondary particles having a large macroporosity created by the salt crystallization.

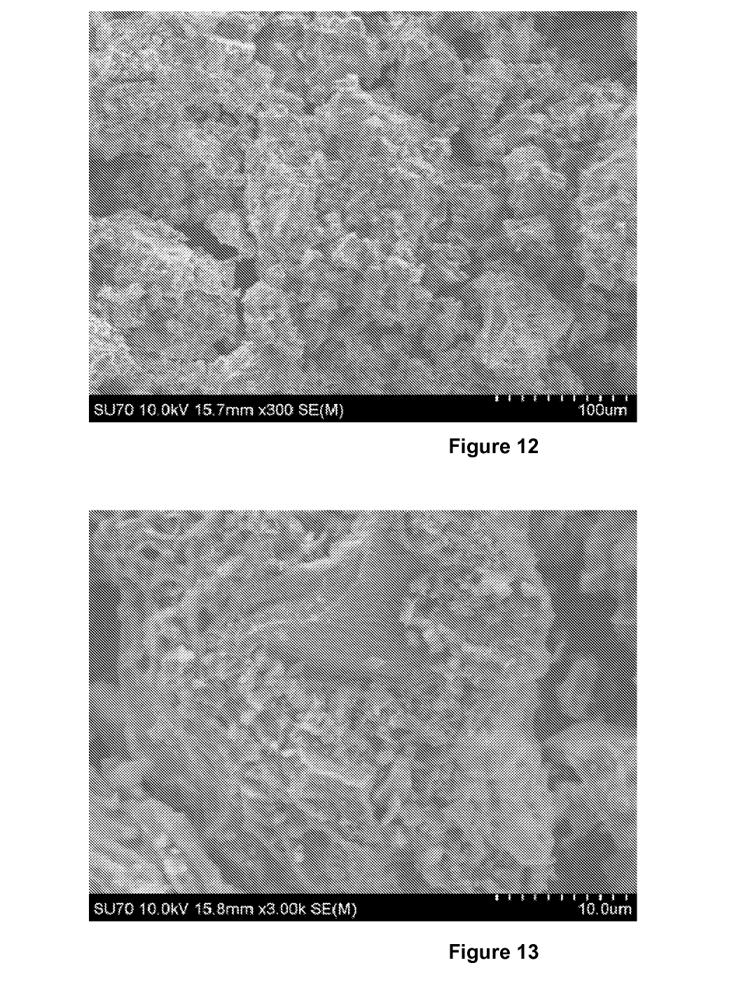

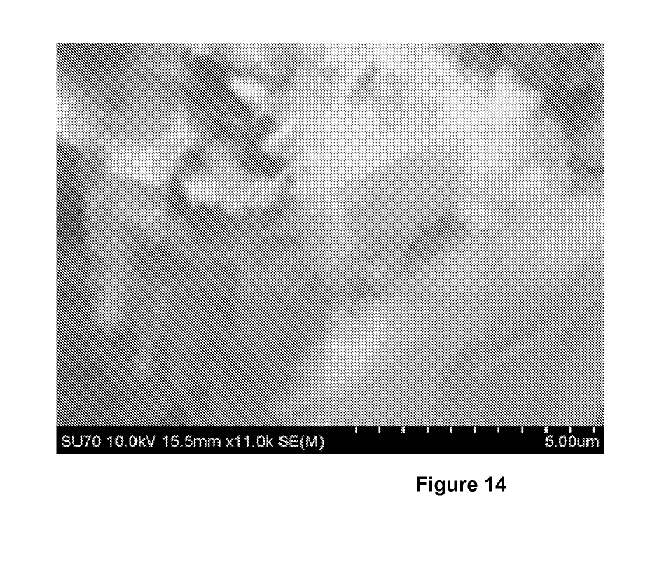

FIGS. 12-14 show SEM images of the material of Example 1 b, having the formula of Na₂CoSiO₄ and produced in accordance with the exemplary synthesis method shown in FIG. 1, but where the mixture is not subjected to the annealing step (i.e., where the annealing step is omitted from the synthesis method). As shown in FIGS. 12-14, there are large agglomerations (i.e., secondary particles) of 20 μm to 100 μm in size. (FIGS. 12 and 13). This material is not as crystalline as the materials that are fired to high temperatures (e.g., as shown in FIGS. 5-11). They show agglomerations of particles (FIG. 12) with macropores (FIG. 13). As the primary particles size is very small, it is difficult to see with the resolution of the SEM. In some cases this may be a more amorphous type material. FIG. 14 shows the very small particles sizes of the primary particles as very light ‘fluffy’ masses.

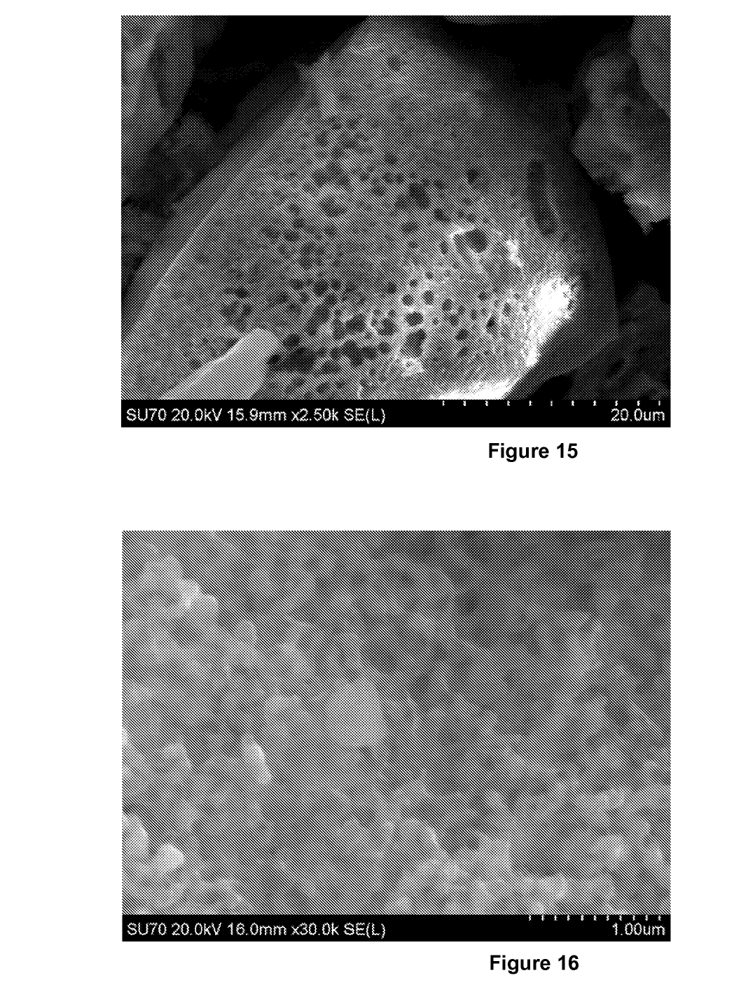

FIGS. 15 and 16 show SEM images of the material of Example 5, having the formula of Na₂Mn₂Si₂O₇ and produced in accordance with the exemplary synthesis method shown in FIG. 1. These images also show the macroporous morphology of the material. The material shown in FIG. 15 is the secondary particle, which is formed from and agglomeration of primary particles. The secondary particle can clearly be shown to exhibit macroporosity. FIG. 16 shows the SEM of one of the particles at a higher resolution (1 μm), this shows that the secondary particles are typically made from primary particles which are less than 200 nm in size. The pore size of the material is similar to that of the material shown in FIGS. 5 and 6.

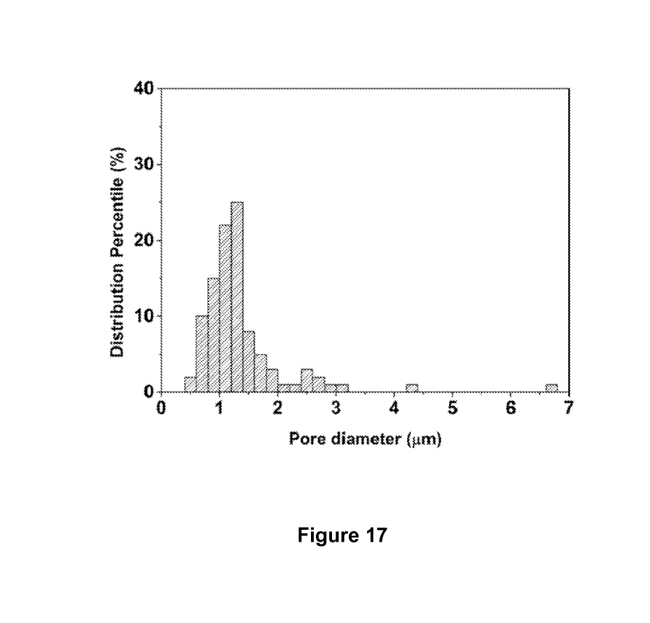

The apparent pore size distribution of the material of Example 5 is shown in FIG. 17. The apparent pore size distribution was taken by measurement of observed porous structures in the sample. Measurements were taken of the longest judged diameter of each pore from the calibrated Scanning Electron micrographs. As shown, the range of pore sizes measured was typically between 0.5 μm and 3 μm. The majority of the pores were less than 1.5 μm, and 25% were in the region 1.2 μm to 1.4 μm.

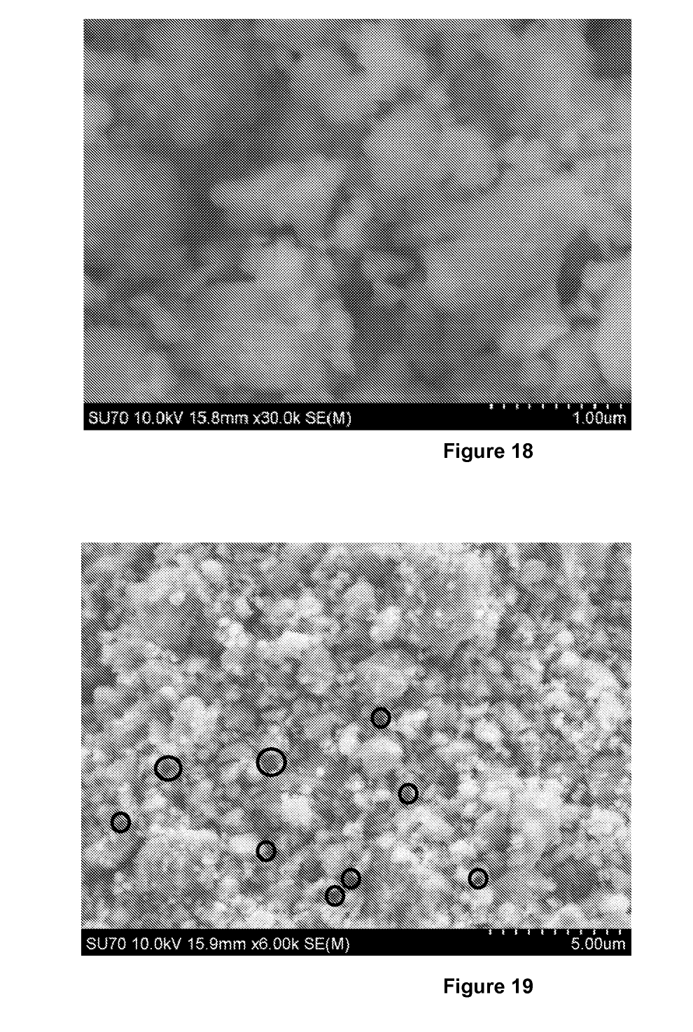

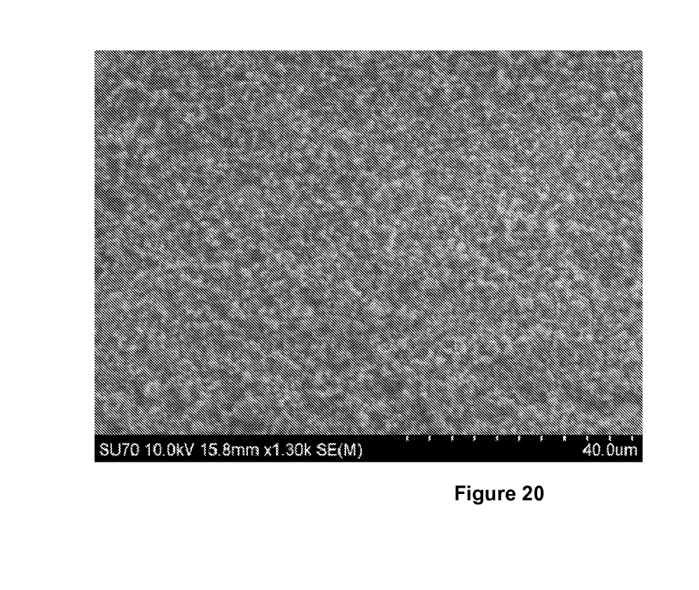

FIGS. 18-20 show other SEM image of the material of Example 5, having the formula of Na₂Mn₂Si₂O₇ and produced in accordance with the exemplary synthesis method shown in FIG. 1. The figures further show that this material is an agglomeration of smaller primary particle sizes, e.g., in the range of primary particle sizes in the range of less than 200 nm (FIGS. 18 and 19). FIG. 20 shows the surface of a secondary particle which include an agglomeration of the primary particles and shows the macroporous nature of the material. The darker spots show the inherent macroporosity of the material. This is slightly different from the Na₂CoSiO₄ shown in FIGS. 5-11, because the material is not as well sintered. Therefore the primary particles are much more obvious and discrete rather than sintered together, and the macro pores are shown as areas with no primary particles. Some of the more apparent macro pores of around 500 nm in size are circled in FIG. 19. In FIG. 20 the surface of the secondary particle, larger pores of up to 5 microns are observed.

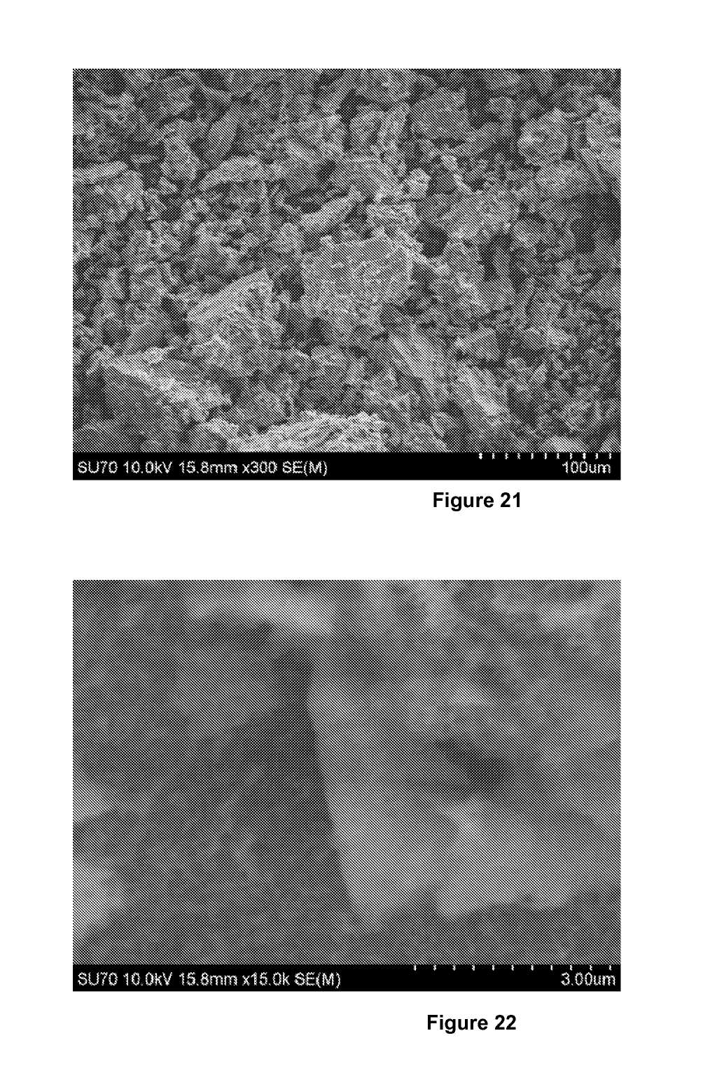

FIGS. 21 and 22 show SEM images of the material of Example 5b, having the formula of Na₂Mn₂Si₂O₇ and produced in accordance with the exemplary synthesis method shown in FIG. 1, but where the mixture is not subjected to the annealing step (i.e., where the annealing step is omitted from the synthesis method). FIG. 21 shows the secondary particle size agglomerations which range from 10 μm-100 μm in size variation. The primary particles are very small (FIG. 22) and look to be less than 200 nm in size. The agglomerations look similar to mossy growths, which indicate the small particles size. The macro pores can be observed in FIG. 22 and typically look to be less than 500 nm in size.

Silicate type materials are known to have low intrinsic electronic conductivities. The sodium transition metal silicate material produced in accordance with the synthesis method of the present disclosure has a small primary particle size which leads directly to, via the use of a conductive additive, a greater number of highly conductive electronic paths connecting particles of the material when processed into an electrode. This increases the realised capacity, demonstrating the usefulness of the sodium transition metal silicate material. In addition, the large secondary particles which are formed from the agglomeration of primary particles have an inherent macro porosity as observed under SEM.

This macro porosity allows electrolytes to soak into the particles, which allows for better ionic conducting electrodes. The formation of these large porous secondary particles is also beneficial for electrodes, this is because less binder is required than if using only the nano materials. This leads to higher energy density electrodes and cells.

Brunauer-Emmett-Teller (BET) measurements were performed for the materials produced in Example 1 and comparative Example 1a (both formed of Na₂CoSiO₄), as well as Example 5 (formed of Na₂Mn₂Si₂O₇). The results are shown in table 2, below.

TABLE 2
Summary of BET results for Example 1,
comparative Example 1a, and Example 5

| | Example 1 | Example 5 | Example 1a |
|---|---|---|---|
| BET Surface Area/m²/g | 5.7609 | 4.6248 | 1.1590 |
| Pore Volume/cm³/g | 0.0121 | 0.0105 | 0.0017 |
| BJH Ads Pore diam./nm | 8.2536 | 9.8538 | 8.9382 |
| BJH Desorp Pore diam./nm | 5.9241 | 7.1041 | 7.0401 |
| Average Pore Diameter/nm | 7.0889 | 8.4790 | 7.9892 |
| Qm/g/cm³ STP | 1.3234 | 1.0624 | 0.2662 |
| Micropore Volume cm³/g | −0.0008 | −0.0008 | 0.0001 |
| Micropore Area m²/g | * | * | 0.2533 |
| External Surface Area/m²/g | 6.9567 | 5.9298 | 0.9056 |

* negative volume indicates the absence of microporosity;
BJH—Barrett-Joyner-Halenda;
Qm - BET monolayer capacity;
STP—standard temperature and pressure.

BET shows that there is very little microporosity in these materials, with the samples synthesised in accordance with the synthesis method of the present application having either no microporosity or a negligible amount of microporosity present. By contrast, the sample made by the solid state method (Example 1a) has a small level of microporosity (0.25 m²/g). The mesoporosity shows an average pore size of 5 nm to 10 nm for all samples, however the samples made by this method show higher pore volumes 0.01 cm³/g to 0.02 cm³/g.

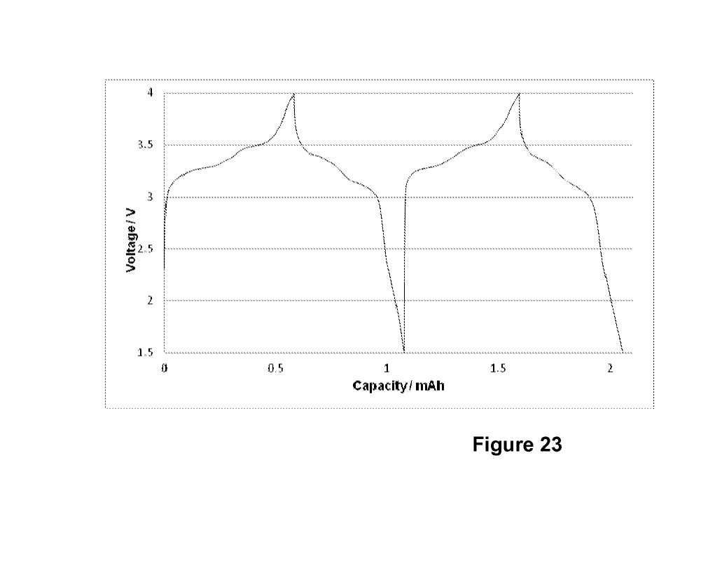

As described above, the sodium transition metal silicate material of the present disclosure may be embodied as an electrode for use in a sodium-ion battery. As an illustrative test example, the material of Example 1 of Table 1 having the formula Na₂CoSiO₄, produced in accordance with the exemplary synthesis method shown in FIG. 1, was sodium metal electrochemical test cell. The sodium transition metal silicate material of Example 1 was processed along with a carbon-based additive and binding agent into an electrode which was then cycled electrochemically against a metallic sodium foil anode. FIG. 23 is a voltage vs. capacity plot of Na₂CoSiO₄ used as the active material in a sodium-ion cell. Cycled 1.5 V-4 V vs. Na/Na+, C/20 rate (assuming 100 mAhg-1), vs. metallic sodium, 0.5 M NaClO4 in propylene carbonate electrolyte. FIG. 23 shows high specific capacities of about 110 mAhg-1 at high average redox potentials of 3.3V.

Although the invention has been shown and described with respect to a certain embodiment or embodiments, equivalent alterations and modifications may occur to others skilled in the art upon the reading and understanding of this specification and the accompanying drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The sodium transition metal silicate material of the present disclosure may be utilized as an active material in a sodium-ion based energy storage device, and as a porous transition metal catalysis.

Lithium-ion intercalation type batteries are common place throughout the world and as such are already a large and established market. Very few sodium-ion based intercalation devices are currently on the market but this is set to change as demand for lithium increases and cost-effective sodium-ion devices become a more viable technology. Sodium transition metal silicates are potential cathode materials for this technology due to their robust structures and high redox potentials. The materials must be porous, possessing a small particle size and of a high purity. This will ensure that the electrochemical properties of the material can be enhanced. This patent provides such a material.

Catalysts are used in a wide variety of industries in order to improve the efficiencies of commercial chemical reactions and as such the potential use of a catalyst in the desired form could be widespread. A famous example of a widespread catalytic process is the catalytic cracking of oil, a mix of long-chain hydrocarbons, into smaller chains. This is typically achieved using a catalyst with a high surface area which is robust enough to withstand the high temperatures required. Aluminosilicates embedded with transition metals are currently the most widely used of these catalysts which emphasises the suitability of transition metal silicate based materials for use as catalysts.

1. A method of forming a macroporous sodium transition metal silicate material comprising a composition represented by Chemical Formula (1):
AₐM¹_{b}M²_{c}X_{d}Oₑ (1)
wherein
A is sodium or a mixture of sodium with lithium and/or potassium;
M¹ is one or more transition metals;
M² is one or more metals and/or metalloids;
X is silicon or a mixture containing silicon and one or more elements selected from phosphorus, boron and aluminium;
a is >0;
b is >0;
c is ≧0;
d is ≧1; and
e is ≧2, the method comprising:
mixing one or more transition metal precursor materials in a solvent to form a transition metal mixture;
adding one or more silicate precursors to the transition metal mixture to form a precursor mixture;
adjusting the pH of the precursor mixture to form a mixture of a precipitate of a silicate and a metal cation;
stirring the mixture including the precipitate;
aging the stirred mixture including the precipitate;
drying the aged mixture including the precipitate to remove the solvent therefrom, the drying forming one or more secondary salts;
washing the mixture including the precipitate and the one or more secondary salts with an additional solvent to remove the secondary salt; and
drying the washed mixture.

2. The method of claim 1, further comprising annealing the aged and dried mixture including the precipitate and the one or more secondary salts prior to washing.

3. The method of claim 2, wherein the annealing is performed at a temperature of 120° C. to 1000° C. for a time of 10 minutes to 12 hours.

4. The method of claim 1, wherein the one or more transition metal precursors comprises one or more of chloride, fluoride, iodide, sulfate, nitrate, and carbonate.

5. The method of claim 1, wherein the solvent comprises one or more of water, ethanol, ethylene glycol, methanol, isopropyl alcohol, ether, acetonitrile and hexanol.

6. The method of claim 1, wherein the one or more silicate precursors comprises one or more of tetra ethylene orthosilicate, sodium metasilicate, and sodium orthosilicate.

7. The method of claim 6, wherein the one or more silicate precursors is dissolved in a silicate precursor solvent prior to addition to the transition metal mixture, the silicate precursor solvent comprising one or more of tetra ethylene orthosilicate, sodium metasilicate, and sodium orthosilicate.

8. The method of claim 1, wherein the aging is performed at a temperature of 25° C. to 80° C. for a time of 2 hours to 14 days.

9. The method of claim 1, wherein the drying is performed at a temperature of 100° C. to 150° C. in vacuum oven for a time of 2 hours to 24 hours.

10. The method of claim 1, wherein A is 100% sodium.

11. The method of claim 1, wherein M¹ is one or more of titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold.

12. The method of claim 1, wherein M² is one or more of magnesium, zinc, calcium, beryllium, strontium, barium, aluminium and boron.

13. A macroporous sodium transition metal silicate material comprising a composition represented by Chemical Formula (1):
AₐM¹_{b}M²_{c}X_{d}Oₑ (1)
wherein
A is sodium or a mixture of sodium with lithium and/or potassium;
M¹ is one or more transition metals;
M² is one or more metals and/or metalloids;
X is silicon or a mixture containing silicon and one or more elements selected from phosphorus, boron and aluminium;
a is >0;
b is >0;
c is ≧0;
d is ≧1; and
e is ≧2.

14. The macroporous sodium transition metal silicate material of claim 13, wherein an average pore size of the material ≧50 nm.

15. The macroporous sodium transition metal silicate material of claim 13, wherein the material comprises primary particles comprising the composition represented by Chemical Formula (1) and having an average size of equal to or less than 300 nm.

16. The macroporous sodium transition metal silicate material of claim 15, further comprising secondary particles comprising the composition represented by Chemical Formula (1), the secondary particles comprising an agglomeration of the primary particles, the secondary particles having an average size of 10 μm to 100 μm.

17. The macroporous sodium transition metal silicate material of claim 13, wherein the material has a surface area of ≧2 m²/g.

18. The macroporous sodium transition metal silicate material of claim 13, wherein A is 100% sodium.

19. The macroporous sodium transition metal silicate material of claim 13, wherein M¹ is one or more of titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold.

20. The macroporous sodium transition metal silicate material of claim 13, wherein M² is one or more of magnesium, zinc, calcium, beryllium, strontium, barium, aluminium and boron.
